(19) United States
(12) Patent Application Publication
(10) Pub. No.: US 2014/0122299 A1
(43) Pub. Date: May 1, 2014

(54) SYSTEM AND METHOD FOR FACILITATING SELECTION OF REAL ESTATE AGENTS

(71) Applicant: Burt Klein, Las Vegas, NV (US)

(72) Inventor: Burt Klein, Las Vegas, NV (US)

(21) Appl. No.: 14/065,306

(22) Filed: Oct. 28, 2013

Related U.S. Application Data
(60) Provisional application No. 61/718,931, filed on Oct. 26, 2012.

(51) Int. Cl. G06Q 50/16; G06Q 30/06

(52) U.S. Cl. CPC G06Q 50/16; G06Q 30/0623
USPC 705/26.62; 705/26.61

(57) ABSTRACT

Systems and methods for facilitating the selection of a real estate agent online, which includes storing agent location data relating to a plurality of real estate agents, comparing property location data with the agent location data to identify the one or more real estate agents from the agent location data who are the geographically closest agents to the property listed for sale, and displaying at least a portion of the identified real estate agents and information regarding the property through a user interface.

### CROSS REFERENCE TO RELATED APPLICATIONS

This application claims priority to U.S. Provisional Application Ser. No. 61/718,931, filed Oct. 26, 2012, the disclosure of which is hereby incorporated by reference in its entirety.

### BACKGROUND OF THE INVENTION

1. Field of the Invention

The invention generally relates to systems and methods for providing and promoting greater interactivity and utility for real estate industry professionals and patrons thereof, including home buyers.

2. Background of the Related Art

While property listing information has long been made available through a multiple listing service (MLS), the MLS provides very little direct information regarding the neighborhood around the property which is often a critical factor for a potential home buyer considering a purchase, or renter considering a lease or rental property. The potential home buyer often relies on the knowledge and expertise of a real estate agent for such information. There are often very many real estate agents covering any particular market at the same time. In selecting a real estate agent, it is therefore of importance to the home owner that the real estate agent have knowledge of the area in which a property of interest is located.

For at least the foregoing reasons, there is a compelling need in the art for systems and methods that would enable a potential home buyer or renter to select and work with real estate agents that are particularly knowledgeable regarding the geographical area in which a property of interest is located.

### SUMMARY OF THE INVENTION

Some embodiments of the invention provide a system and method for addressing the needs mentioned above, among other things.

Some embodiments of the invention are directed to a method of facilitating selection of a real estate agent online, comprising the steps of: storing registration data relating to a plurality of real estate agents in a database, wherein the registration data includes agent contact data and agent location data for the one or more real estate agents identifying a geographical location associated with each agent; receiving property data relating to a property listed for sale through a communication interface, wherein the property data includes property location data identifying a geographical location associated with the property; a processor facilitating the step of comparing the property location data with agent location data to identify the one or more real estate agents from the agent location data being closest in physical proximity to the property listed for sale; and actuating the display through the communication interface of the identified one or more real estate agents, the property listed for sale and the physical distance between the agent location data and the property location data for the identified one or more real estate agents on a webpage, including a link associated with each one of the identified one or more real estate agents and responsive to receiving indication of being selected to actuate the display of agent contact data for the associated real estate agent.

In some embodiments, the aforementioned method further comprises the steps of detecting the selection of a link and transmitting notification thereof to the associated real estate agent. The notification may include an invoice for services relating to storing the registration data for the agent.

In some embodiments of the aforementioned method, the registration data further includes agent profile data relating to each one of the plurality of real estate agents, wherein the agent profile data includes information received regarding the agent. In some embodiments, the method further includes the steps of receiving a search selection, comparing the search selection with the agent profile data to identify an initial group of one or more real estate agents, wherein the property location data is compared with agent location data for the initial group.

Some embodiments of the invention are directed to a system for facilitating selection of a real estate agent online, comprising: a database for storing registration data relating to a plurality of real estate agents in a database, wherein the registration data includes agent contact data and agent location data for the one or more real estate agents identifying a geographical location associated with each agent; a communication gateway device for receiving property data relating to a property listed for sale through a communication interface, wherein the property data includes property location data identifying a geographical location associated with the property; a processor for comparing the property location data with agent location data in the database to identify the one or more real estate agents from the agent location data being closest in physical proximity to the property listed for sale; and a user interface displayed on a display device through the communication gateway device, wherein the display includes the identified one or more real estate agents, the property listed for sale and the physical distance between the agent location data and the property location data for the identified one or more real estate agents on a webpage, wherein the display further includes a link associated with each one of the identified one or more real estate agents and responsive to receiving indication of being selected to actuate the display of agent contact data for the associated real estate agent.

In some embodiments, the database receives information relating to the selection of a link and the communication gateway device is configured for transmitting notification thereof to the associated real estate agent. The notification may include an invoice.

In some embodiments, the registration data in the database further includes agent profile data relating to each one of the plurality of real estate agents, wherein the agent profile data includes information received regarding the agent. The user interface may display a search option and the communication gateway device and processor is responsive to receiving a search selection, comparing the search selection with the agent profile data to identify an initial group of one or more real estate agents, wherein the property location data is compared with agent location data for the initial group.

### BRIEF DESCRIPTION OF THE FIGURES

So that those having ordinary skill in the art to which at least some embodiments of the invention pertains will more readily understand how to make and use systems and methods in accordance therewith, such embodiments thereof will be described in enabling detail herein below with reference to the drawings, wherein:

FIG. 1 is a flow diagram depicting operational steps employed by a system and method formed in accordance with some embodiments of the invention;

FIG. 2 is an exemplary user interface configured and displayed in accordance with the invention; and

FIG. 3 illustrates a block diagram of representative components of a real estate agent selection system in which certain embodiments such as the embodiment shown in FIG. 1 may be employed.

### DETAILED DESCRIPTION OF THE INVENTION

In some embodiments, the systems and methods of the invention facilitate enhanced interaction between property buyers, sellers and/or renters with agents based on the geographical location of the relevant parties and subject property.

In particular, the embodiments described herein generally relate to systems and methods for facilitating selection of a real estate professional, commonly referred to as a real estate agent which are preferably implemented with or through software programs, conventional hardware components, such as processing and data storage devices, and communication over a global communication network, such as the Internet. It is expected that one of ordinary skill, notwithstanding possibly significant effort and many design choices motivated by, for example, available time, current technology, and economic considerations, when guided by the concepts and principles disclosed herein will be readily capable of generating such software programs and appropriate hardware for execution thereof with minimal experimentation. Therefore, in the interest of brevity and minimization of any risk of obscuring the principles and concepts according to the present invention, further discussion of such software, if any, will be limited to the essentials with respect to the principles and concepts used by the preferred embodiments.

Some embodiments of the invention disclose a new and useful tool for facilitating selection of a real estate agent, and in particular, identifying real estate agents that have knowledge of a geographical area in which a property listing of interest to a home buyer is located, communicating the identified real estate agents to potential home buyers or renters and recording the subsequent selection of interest in an identified real estate agent. It is envisioned that information would be received regarding the real estate agents and the communication of identified real estate agents would be provided through a data communication device. The data communication device may also receive and populate the property listing data from any one or more sources, such as the MLS, on a user interface, such as a webpage. In some embodiments, one or more agents may be identified for each property and displayed on the user interface along with the property listing information.

While the embodiments discussed herein provide systems and methods for facilitating the selection of a real estate agent, it should be understood that these are non-limiting, exemplary embodiments of systems and methods of the invention.

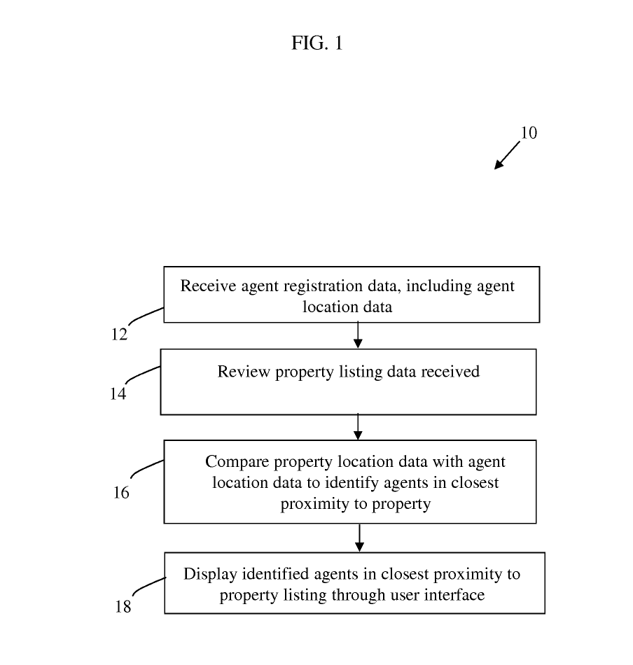

FIG. 1 provides a process flow diagram which illustrates operational steps employed by an exemplary embodiment of the method of the invention referred to as method 10.

As shown by step 12, agent registration data relating to a real estate agent is received and stored in a database. The agent registration data may include an agent profile containing a variety of information relating to an agent, such as contact information, location data such as home address, company information, office location, personal interests, professional accomplishments, testimonials and ratings.

As shown by step 14, property data relating to a property listed for sale, including the property geographical location, such as a physical address, is received, reviewed or considered by method 10. In some embodiments, the property data may be received and/or reviewed upon retrieving property data responsive to a search for available properties conducted by a user. The property data may be received through any source, such as the MLS feed.

As shown by step 16, the property location data is compared with the agent location data for each real estate agent having registration data stored in the database to identify a plurality of real estate agents who are closest in proximity to the property location. The proximity measurements may be obtained by any conventional means, such as for example, converting addresses to longitude and latitude coordinates, and then considering the distance between the longitude and latitude of the agent, according to the agent location data, and the property address, based on the property location data. In this embodiment exemplified by method 10, the agent location data is associated with the home address of the agent, but in other embodiments, the location data may be associated with an area the agent inputs with their registration data or is assigned, such as an area that the agent is familiar with. In some embodiments, agents may be required to provide some support or verification of such familiarity with any geographical area, particularly if the area differs from the home address of the agent.

As shown by step 18, the identified plurality of real estate agents being closest in proximity to the property location as compared with all other real estate agents is displayed on a user interface along with the property data.

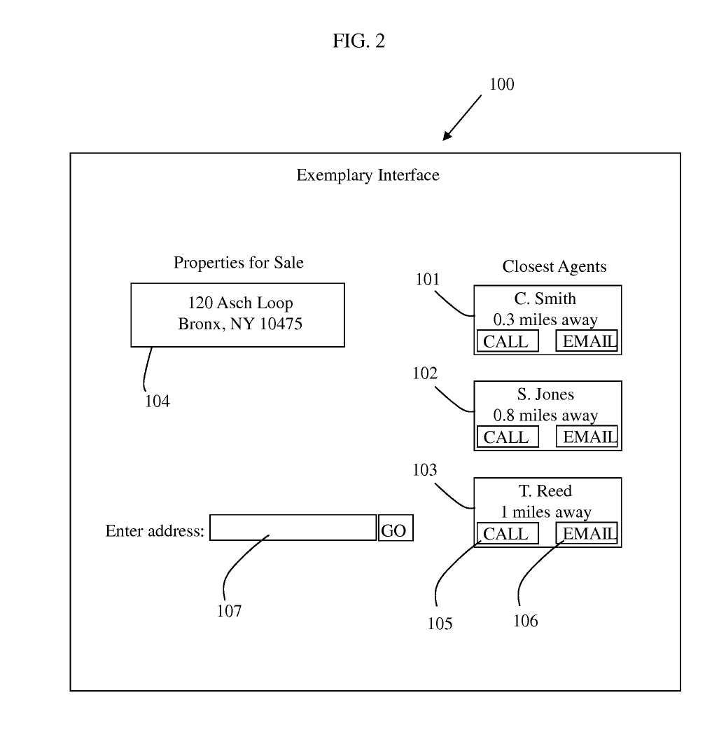

An exemplary interface 100 is shown in FIG. 2. In this embodiment, user interface 100 provides information for three identified agents, agents 101, 102 and 103, who are associated with locations such as their home addresses (not shown), which are closest in proximity to property shown in box 104 when compared to all other registered agents (having submitted registration information). The identified agents 101, 102 and 103 are displayed along with approximate distances their associated locations are from the property shown in box 104. Box 104 may include pictures of the property.

With regard to interface 100, it should be understood that any graphical user interfaces may be employed by embodiments disclosed herein for display as a webpage which incorporate user-friendly features and fit seamlessly with other operating system interfaces, that is, in a framed form having borders, multiple folders, toolbars with drop or pull-down menus, embedded links to other screens and various other selectable features associated with animated graphical representations of depressible buttons. These features can be selected (i.e., “clicked on”) by the user via connected mouse, keyboard, touch screen or other commonly used tool for indicating a preference in a computerized graphical interface.

As shown by step 20, a set of contact links, a “call” link 105 and an “email” link 106 for each agent 101, 102 and 103 is provided to facilitate contact with the associated agent. Contact information may be displayed or calls or emails may be initiated to the associated agent responsive to selecting links 105 or 106.

As shown in step 22, the selection of a link is recorded. In some embodiments, a notification may be transmitted to the agent responsive to selection of a link. The notification may be transmitted to the agent through any means, such as email or text. In some embodiments, the selection of a link is recorded and all link selections recorded may be periodically aggregated for billing purposes. In some embodiments, a contact form may be pre-populated upon selection of a link, such as a call or email link, and recorded for billing purposes responsive to the contact form being finalized by a user, that is, the user causing the filled form to be transmitted to the agent.

In some embodiments, a method such as the method 10 described above may further include a feature enabling users to submit criteria that can then be used to sort and parse agents into a group composed of agents satisfying the criteria. The criteria may be based on any information submitted with their registration data or associated with the agent, such as the company the agent works for, office location, experience, professional accomplishments or certifications, testimonials or ratings that may be provided through customer feedback. The location data for the agents who satisfy the criteria will then be compared with the property location data as described above with regard to step 16. The agents of the group who are closest in proximity to the property listed for sale or rent will be displayed through a communication device, which may appear as user interface 100.

In some embodiments, a person, such as a home owner or owner of rental property for example, may enter in an address to a method such as method 10, rather than receive a property address. An address entry field 107 is shown in interface 100 to facilitate the entering of an address. The address entered will be converted to latitude and longitude coordinates, if necessary, and/or otherwise compared with the agent location data as described above with regard to step 16. One or more agents will be identified and displayed on the user interface 100 based on their geographical proximity to the address into field 107, which may then be shown in box 104.

In some embodiments, the systems and methods provide for, among other things: receiving property data from a user relating to a subject property and geographical location thereof; identifying one or more agents based on information stored in a database relating to the geographical location of the agents with respect to the subject property; and displaying information regarding the one or more agents having geographical locations being closest in proximity to the subject property.

In some embodiments, the systems and methods provide for, among other things: receiving agent data from relating to the geographical locations of one or more agents; receiving property information and a request for an agent, wherein the property information includes a geographical location of the property; identifying the one or more agents closest in proximity to the property based on geographical location; and displaying the one or more agents identified in response to the request for an agent.

In some embodiments, the present invention comprises a series of webpages or a mobile application in which allow users to see and share information related to agents and subject properties as described herein.

By using systems and methods of the invention, users will have strong confidence in the system, since local agents of the properties in question have the knowledge of not only the property of interest, but that of the community in itself. Those agents, within the community of the properties being selected will be called upon, since they themselves are neighbors of that community and can provide accurate information. Agents who register free of charge, will receive texts and emails in real time, as new and existing clients are browsing properties within their jurisdiction. In addition, a toll free call center may be assigned, giving the user's additional confidence, knowing that the company offers support, should they require additional information, as well as live assistance.

The system and method of the invention will further provide data regarding the nearest amenities to the user's properties of interest, including but not limited to schools, shopping, libraries etc., utilization of maps and displaying the amenities subject to the location of the selected properties of interest.

In some embodiments, when a user chooses a property, three agents closest to the property will be populated on the website, thus giving the user/client information on the closest agents to the selected property based on the agent's geographical location. The user can then contact any of those closest agents via text, email or by simply calling them. The user may also have the opportunity to call up the company and the company will manually dispatch the closest agent without the client having to wait for a call back. In addition, applications utilizing geolocation through mobile devices including but not limited to cell phones, tablets etc, which agents can download for free, will enable call centers for systems and methods of the invention to allocate agents/brokers who may be mobile and in an area closest to the property of interest.

In some embodiments, systems and methods of the invention may be leased, licensed or otherwise made available to realtors, franchisers, or other entities that wish to utilize and/or integrate the system and methods into an existing website.

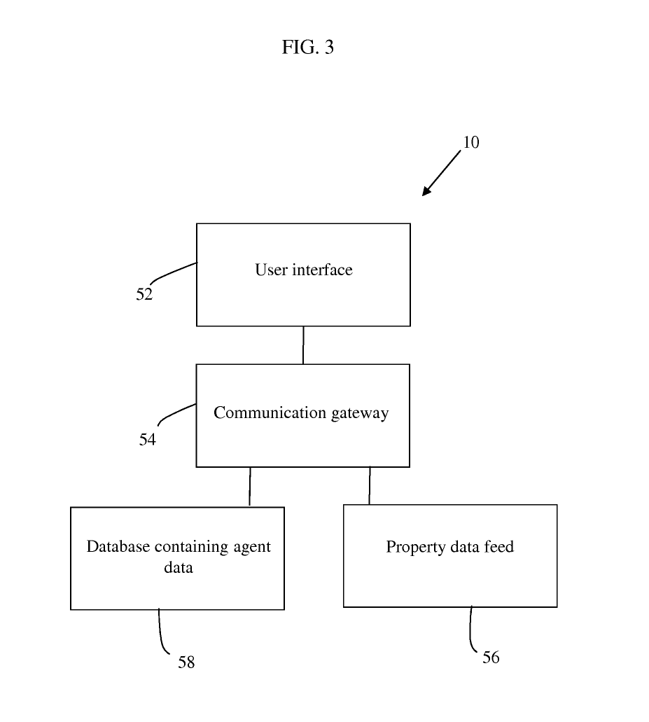

FIG. 3 illustrates a block diagram representative of an example electronic real estate transaction management system 50 in which certain embodiments may be employed. System 10 includes a user interface 52, a communication gateway 54, a property data feed 56, and a database 58, containing real estate agent registration data that includes location data for the real estate agent. User interface 52 is in communication with the communication gateway 54. Gateway 54 is in communication with the property data feed 56 in order to receive or obtain the property listing data for display on user interface 52, and database 58 for comparing the listing data with the agent location data for purposes of displaying the agents of closest proximity to any property for display on user interface 52 along with the property listing. It should be understood that this embodiment may be used to provide proximal agents in combination with an existing system for providing property data.

As used herein, the phrase “in communication” encompasses direct communication and/or indirect communication through one or more intermediary components. The exemplary electronic system 50 depicted in FIG. 3 may be in communication with additional components, subsystems, and elements to provide additional functionality and capabilities without departing from the teaching and disclosure provided herein.

In operation, the interface 52 may receive property listing data from feed 56 through the communication gateway 54 for one or more properties for sale. The property listing data may include a variety of pictures and information about the property for sale, such as the type of property, history of the property, school district, and property location data, such as the city, county, state, zip code, mailing address. System 50 will compare the property location data with the agent location data in database 58 to identify the agents who are associated with locations that are in closest proximity to the location of the property listing. In an embodiment of user interface 52, information for the three closest agents will be displayed with the property listing data as shown in interface 100.

A user, such as a home seller, buyer or renter, may utilize the user interface 52 to search and review listings of properties currently available, and upon displaying each on user interface 52, also be shown one or more of the closest agents to each property listing.

User interface 52 may be provided on any electronic computing platform, such as a desktop computer, hand-held device, laptop, server, a portable computing device, or a terminal, which may include a display and be in communication with a server. Gateway 54 may also include one or more electronic computing platforms. For example, gateway 54 may be implemented as a desktop computer, hand-held device, laptop, server, a portable computing device, a terminal, a workstation with a single or multi-core processor, cluster of computers, databases, servers, or any combination thereof.

Gateway 54 may also facilitate communication. For example, gateway 54 may perform protocol translation for data communicated between the user interface 52 and property listing feed 56 and database 58.

System 50 may include additional, different, or fewer components. For example, system 40 may include multiple interfaces, gateways, data feeds and/or databases.

Exemplary systems constructed in accordance with embodiments of the invention may include data storage devices or databases, control programs, data processors, and communication devices for receiving and transmitting data. Those skilled in the art will readily appreciate that a system in accordance with some embodiments of the invention may include various computer and network related software and hardware, that is, programs, operating systems, memory storage devices, data input/output devices, data processors, servers with links to data communication systems, wireless or otherwise, such as the world wide web or a local or wide area network, and a plurality of data transceiving terminals capable of interfacing with the network.

Those skilled in the art will readily appreciate that a system in accordance with some embodiments of the invention may include various computer and network related software and hardware, that is, programs, operating systems, memory storage devices, data input/output devices, data processors, servers with links to data communication systems, wireless or otherwise, such as those which take the form of a local or wide area network, and a plurality of data transceiving terminals capable of interfacing with the network, such as personal computers, handheld devices, personal digital assistants (PDAs), cell phones or any other devices capable of displaying a graphical user interface.

Those skilled in the art will further appreciate that the particular types of communication network and devices, software and hardware are not vital to the full implementation of the embodiments described herein or other embodiments within the scope and spirit of the invention. Although the description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways. Furthermore, well known process steps and computer components may have not been described in detail herein in order to avoid unnecessarily obscuring the underlying concepts.

It should be further understood that the type of communication network and devices, software and hardware may also vary and the precise software and hardware configuration of the various embodiments of the invention may vary accordingly while still remaining within the scope and spirit of the invention. With the continuous and ongoing improvements in computer and electronic technology, many modifications may be made to the specific nature of hardware and/or software components required. Accordingly, one of skill in the art may select any hardware components that would rapidly and efficiently process the data and provide storage and communication as needed for the successful operation of some embodiments of the invention.

It will be appreciated by those skilled in the art that while the disclosure of the invention has been described herein in connection with particular embodiments and examples, the invention is not necessarily so limited, and that numerous other embodiments, examples, uses, modifications and departures from the embodiments, examples and uses are intended to be encompassed by the spirit and scope of the invention claimed as would be understood to one of ordinary skill in the art.

What is claimed is:

1. A method of facilitating selection of a real estate agent online, comprising the steps of:
a) storing registration data relating to a plurality of real estate agents in a database, wherein the registration data includes agent contact data and agent location data for the one or more real estate agents identifying a geographical location associated with each agent;
b) receiving property data relating to a property listed for sale through a communication interface, wherein the property data includes property location data identifying a geographical location associated with the property;
c) a processor facilitating the step of comparing the property location data with agent location data to identify the one or more real estate agents from the agent location data being closest in geographical proximity to the property listed for sale; and
d) actuating the display through the communication interface of the identified one or more real estate agents, the property listed for sale and the physical distance between the agent location data and the property location data for the identified one or more real estate agents on a webpage, including a link associated with each one of the identified one or more real estate agents and responsive to receiving indication of being selected to actuate the display of agent contact data for the associated real estate agent.

2. The method according to claim 1, further comprising the steps of detecting the selection of a link and transmitting notification thereof to the associated real estate agent.

3. The method according to claim 2, wherein the notification includes an invoice.

4. The method according to claim 1, wherein the registration data further includes agent profile data relating to each one of the plurality of real estate agents, wherein the agent profile data includes information received regarding the agent.

5. The method according to claim 4 further comprising the steps of receiving a search selection, comparing the search selection with the agent profile data to identify an initial group of one or more real estate agents, wherein the property location data is compared with agent location data for the initial group.

6. A system for facilitating selection of a real estate agent online, comprising:
a) a database for storing registration data relating to a plurality of real estate agents in a database, wherein the registration data includes agent contact data and agent location data for the one or more real estate agents identifying a geographical location associated with each agent;
b) a communication gateway device for receiving property data relating to a property listed for sale through a communication interface, wherein the property data includes property location data identifying a geographical location associated with the property;
c) a processor for comparing the property location data with agent location data in the database to identify the one or more real estate agents from the agent location data being closest in geographical proximity to the property listed for sale; and
d) a display device for displaying a user interface actuating through the communication gateway device, the user interface displaying the identified one or more real estate agents, the property listed for sale and the physical distance between the agent location data and the property location data for the identified one or more real estate agents on a webpage, wherein the display further includes a link associated with each one of the identified one or more real estate agents and responsive to receiving indication of being selected to actuate the display of agent contact data for the associated real estate agent.

7. The system according to claim 6, wherein the database receives information relating to the selection of a link and the communication gateway device is configured for transmitting notification thereof to the associated real estate agent.

8. The system according to claim 7, wherein the notification includes an invoice.

9. The system according to claim 6, wherein the registration data in the database further includes agent profile data relating to each one of the plurality of real estate agents, wherein the agent profile data includes information received regarding the agent.

10. The system according to claim 9 wherein the user interface displays a search option and the communication gateway device and processor is responsive to receiving a search selection, comparing the search selection with the agent profile data to identify an initial group of one or more real estate agents, wherein the property location data is compared with agent location data for the initial group.
